(19) United States
(12) Patent Application Publication
(10) Pub. No.: US 2024/0400817 A1
(43) Pub. Date: Dec. 5, 2024

(54) RESIN COMPOSITION

(71) Applicant: NAN YA PLASTICS CORPORATION, TAIPEI (TW)

(72) Inventors: Te-Chao Liao, TAIPEI (TW); Wen-Cheng Yang, TAIPEI (TW); Chun-Che Tsao, TAIPEI (TW); Chia-Yen Hsiao, TAIPEI (TW); Yueh-Shin Liu, TAIPEI (TW)

(73) Assignee: NAN YA PLASTICS CORPORATION, TAIPEI (TW)

(21) Appl. No.: 18/465,174

(22) Filed: Sep. 12, 2023

(30) Foreign Application Priority Data
May 31, 2023 (TW) 112120279
Aug. 28, 2023 (TW) 112132282

(51) Int. Cl. C08L 55/02

(52) U.S. Cl. CPC C08L 55/02; C08L 2205/08; C08L 2205/14; C08L 2207/20

(57) ABSTRACT

A resin composition includes ABS resin and modified polyester resin, where the modified polyester resin includes a polyester material, a compatibilizer, a toughening agent, a crystallization inhibitor, a slip agent, and an antioxidant. The compatibilizer includes PP-MA, PE-MA, ABS-MA, E-MA-GMA, E-VA-GMA, POE-GMA, PE-GMA, ABS-GMA, or combinations thereof. The toughening agent includes POE, MBS, PTW, or combinations of the above. The crystallization inhibitor includes IPA copolyester, IPA and CHDM copolyester, PETG, PCTG, or combinations of the above. The slip agent includes stearate, polyethylene wax, modified silicone, fluororesin, or combinations thereof. The antioxidant includes a hindered phenolic antioxidant, a phenolic antioxidant, a phosphite antioxidant, or combinations of the above.

### CROSS-REFERENCE TO RELATED APPLICATION

This application claims the priority benefit of Taiwan application serial no. 112120279, filed on May 31, 2023 and Taiwan application serial no. 112132282, filed on Aug. 28, 2023. The entirety of each of the above-mentioned patent applications is hereby incorporated by reference herein and made a part of this specification.

### BACKGROUND

### Technical Field

The disclosure relates to a resin composition.

### Description of Related Art

Due to its balanced mechanical performance, glossy appearance, and electroplating capability, acrylonitrile-butadiene-styrene copolymer resin (ABS resin) has found extensive use in various fields, including household appliances, power tools, electronic devices, office supplies, and so on. However, the ABS resin has the issue of high carbon emissions (ranging from approximately 3.5 kgCO₂/kg to 4 kgCO₂/kg). Therefore, as environmental consciousness grows and the demand for carbon reduction in products increases, introduction or substitution of materials that have lower carbon emissions should be explored.

Specifically, when compared to the ABS resin, polyester resin (PET resin) offers the advantage of lower carbon emissions (ranging from approximately 2.6 kgCO₂/kg to 3 kgCO₂/kg), which may reduce the carbon emissions by about 15% to 35%. Besides, recycled PET resin (RPET) may further reduce the carbon emissions by 60% to 90% depending on the source of recycling as compared to the virgin PET resin and by 70% to 92% as compared to the ABS resin. Hence, introducing the PET resin into the ABS resin may effectively reduce overall carbon emissions. However, there are challenges to overcome when introducing the PET resin into the ABS resin due to their different properties. The ABS resin is an amorphous plastic with low polarity, while the PET resin is a crystalline plastic with high polarity. This mismatch in properties may result in poor compatibility between the ABS resin and the PET resin. Consequently, the introduction of the PET resin into the ABS resin may lead to phase separation, which compromises product mechanical performance and diminishes surface glossiness.

### SUMMARY

The disclosure provides a resin composition capable of achieving an improved mechanical performance while reducing carbon emissions.

In an embodiment of the disclosure, a resin composition including ABS resin and modified polyester resin is provided. The modified polyester resin includes a polyester material, a compatibilizer, a toughening agent, a crystallization inhibitor, a slip agent, and an antioxidant. The compatibilizer includes PP-MA, PE-MA, ABS-MA, E-MA-GMA, E-VA-GMA, POE-GMA, PE-GMA, ABS-GMA, or combinations thereof. The toughening agent includes POE, MBS, PTW, or combinations thereof. The crystallization inhibitor includes IPA copolyester, IPA and CHDM copolyester, PETG, PCTG, or combinations thereof. The slip agent includes stearate, polyethylene wax, modified silicone, fluororesin, or combinations thereof. The antioxidant includes a hindered phenolic antioxidant, a phenolic antioxidant, a phosphite antioxidant, or combinations thereof.

According to an embodiment of the disclosure, an addition amount of the compatibilizer ranges from 8 wt % to 18 wt % relative to a total weight of the modified polyester resin.

According to an embodiment of the disclosure, an addition amount of the toughening agent ranges from 3 wt % to 10 wt % relative to a total weight of the modified polyester resin.

According to an embodiment of the disclosure, an addition amount of the crystallization inhibitor ranges from 2 wt % to 8 wt % relative to a total weight of the modified polyester resin.

According to an embodiment of the disclosure, an addition amount of the slip agent ranges from 0.1 wt % to 2 wt % relative to a total weight of the modified polyester resin.

According to an embodiment of the disclosure, an addition amount of the antioxidant ranges from 0.1 wt % to 1 wt % relative to a total weight of the modified polyester resin.

According to an embodiment of the disclosure, an addition amount of the polyester material ranges from 61.0 wt % to 86.8 wt % relative to a total weight of the modified polyester resin.

According to an embodiment of the disclosure, an addition amount of the ABS resin ranges from 60 wt % to 100 wt % relative to a total weight of the resin composition.

According to an embodiment of the disclosure, a total addition amount of the ABS resin and the modified polyester resin is 100 wt %.

According to an embodiment of the disclosure, the polyester material includes virgin polyester pellets, recycled polyester pellets, or combinations thereof.

Based on the above, the resin composition provided in one or more embodiments of the disclosure introduces the modified polyester resin (using various additives, such as the compatibilizer, the toughening agent, the crystallization inhibitor, the slip agent, and the antioxidant) into the ABS resin system. This may improve the poor compatibility between the two and enhance an impact resistance, fluidity, and heat resistance. As a result, an improved mechanical performance may be achieved while the carbon emissions are reduced.

In order to make the above-mentioned features and advantages of the present disclosure more comprehensible, the following embodiments are given and described in detail as follows.

### DESCRIPTION OF THE EMBODIMENTS

In the following detailed description, for purposes of explanation and not limitation, exemplary embodiments disclosing specific details are set forth in order to provide a thorough understanding of the various principles of the disclosure. It will be apparent, however, to one of ordinary skill in the art, having been benefited from this disclosure, that the present disclosure may be practiced in other embodiments that depart from the specific details disclosed herein. Furthermore, descriptions of commonly-known devices, methods, and materials may be omitted so as not to shift the focus from the description of the various principles of the disclosure.

In this disclosure, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with the any numerical value and the smaller numerical range stated explicitly in the specification.

Ranges may be expressed herein as “about” one particular value to “about” another particular value, which can also be expressed directly as one particular value and/or to another particular value. When expressing the range, another embodiment includes the one particular value and/or to the other particular value. Similarly, when values are expressed as approximations, by use of the antecedent “about,” it will be understood that the particular value forms another embodiment. It will be further understood that an endpoint of each range is clearly related or unrelated to the other endpoint.

Unless otherwise stated, the term “between” used in this specification to define numerical ranges is intended to cover ranges equal to and between the stated endpoints. For instance, if a size range is between a first value and a second value, the size range may cover the first value, the second value, and any value between the first value and the second value.

In the disclosure, non-limiting terms (such as: may, can, for instance, or other similar terms) are non-essential or optional implementation, inclusion, addition, or presence.

Unless otherwise defined, all terms (including technical and scientific terms) used herein have the same meaning as commonly understood by one of ordinary skill in the art to which this disclosure belongs. It will also be understood that terms (such as those defined in commonly used dictionaries) should be interpreted to have meanings consistent with those in the relevant technical context and should not be interpreted in an idealized or overly formal sense, unless explicitly defined as such.

In this embodiment, a resin composition includes ABS resin and modified polyester resin, and the modified polyester resin includes a polyester material, a compatibilizer, a toughening agent, a crystallization inhibitor, a slip agent, and an antioxidant. Thereby, the resin composition provided in one or more embodiments of the disclosure introduces the modified polyester resin (using various additives, such as the compatibilizer, the toughening agent, the crystallization inhibitor, the slip agent, the antioxidant, and a modified polyester material) into the ABS resin system. This may improve the poor compatibility between the two and enhance an impact resistance, fluidity, and heat resistance. As a result, an improved mechanical performance may be achieved while the carbon emissions are reduced.

To be specific, functions of the additives are described below. For instance, the compatibilizer is utilized to improve the compatibility between the ABS resin and the polyester material, decrease the proportion of dispersed polyester material in the ABS resin, and prevent a significant decrease in the impact resistance caused by large-scale phase separation. Therefore, the impact resistance may be effectively enhanced. The toughening agent is utilized to enhance an impact resistance of the dispersed phase of the polyester material and thus may effectively improve the impact resistance. The crystallization inhibitor is utilized to reduce a crystallization speed of the polyester material and prevent crystalline phase separation. The slip agent is utilized to improve fluidity of a material and is conducive to flowability and demolding characteristics during injection molding. The antioxidant is utilized to enhance a heat resistance and a processability of a material. Therefore, by modifying the polyester material with the additives, the modified polyester material may be effectively introduced into the ABS resin system, so as to achieve good mechanical and processing performance without sacrificing the requirements for carbon reduction.

Here, a method of modifying the polyester resin includes, for instance, melting the polyester material into a molten state by a twin-screw extruder, adding the above-mentioned additives to the polyester material and evenly mixing and dispersing the additives and the polyester material, so as to form generate modified polyester resin in a molten state. Next, the molten modified polyester resin is extruded in strip form through a die, and the strip is pelletized by cooling water to obtain the modified polyester resin provided herein. The modified polyester resin may be subsequently mixed and extruded or injection molded with the ABS resin pellets in a dry blending manner to obtain the desired products, which should however not be construed as a limitation in the disclosure.

Details of the ABS resin, the polyester material, the compatibilizer, the toughening agent, the crystallization inhibitor, the slip agent, and the antioxidant are further described hereinafter.

### ABS Resin

In some embodiments, the ABS resin may be formed by copolymerizing acrylonitrile, butadiene, and styrene in appropriate proportions, which should not be construed as a limitation in the disclosure. For instance, a specific example of the ABS resin is the product AG12A0 from the Formosa Chemicals & Fibre Corporation.

In some embodiments, the addition amount of the ABS resin ranges from 60 wt % to 100 wt % relative to the total weight of the resin composition, which should however not be construed as a limitation in the disclosure. Here, the resin composition consists of the ABS resin and the modified polyester resin; in other words, the total addition amount of the ABS resin and the modified polyester resin is 100 wt % (weight percentage), which should however not be construed as a limitation in the disclosure.

### Polyester Material

In some embodiments, the polyester material includes virgin polyester pellets, recycled polyester pellets, or combinations thereof. For instance, due to the poor recyclability of the ABS resin and the limited ability to merely produce black-colored products by applying the recycled ABS resin, the good recyclability (stable and easily distinguishable recycling sources) of the polyester material which may be applied to produce transparent, white, or multicolored products allows the recycled polyester pellets to be introduced into the ABS resin system, which contributes to plastic reduction and reduction in material carbon emissions. Besides, the resultant products are environmentally friendly and multicolored. However, this should not be construed as a limitation in the disclosure. In this case, the mechanical properties and shrinkage of the recycled polyester pellets are similar to those of the virgin polyester pellets.

In some embodiments, the sources of the recycled polyester pellets include recycled pellets for bottles (such as PET bottles), production waste from polyester films, recycled and regenerated polyester pellets from industrial release films, recycled polyester pellets from polyester textiles, recycled pellets from electronic trays, recycled pellets from packaging trays, or combinations thereof, which should however not be construed as a limitation in the disclosure.

In some embodiments, intrinsic viscosity (IV) of the polyester material ranges from 0.6 dL/g to 0.86 dL/g after the polyester material is polymerized. As such, within the range of the IV after the polyester material is polymerized, the polyester material is able to effectively increase a length of a molecular chain and improve properties such as impact resistance, which should however not be construed as a limitation. Here, the IV is determined by applying the ASTM D2857 test method. The IV of the polyester material may be enhanced through solid-state polymerization and/or liquid-state polymerization. The specific implementation manner of the solid-state polymerization may involve subjecting a solid PET material to a low-pressure-high-temperature (150° C. to 180° C.) process to achieve the required IV (from 0.6 dL/g to 0.86 dL/g). The specific implementation manner of the liquid-state polymerization may involve melting a solid PET material into a liquid state and performing vacuum polymerization on the solid PET material in the liquid state in an extrusion device to reach the required IV (from 0.6 dL/g to 0.86 dL/g), followed by a pelletizing process for further processing.

In some embodiments, the addition amount of the polyester material ranges from 61.0wt % to 86.8wt % relative to the total weight of the modified polyester resin, which should however not be construed as a limitation in the disclosure.

### Compatibilizer

In some embodiments, the compatibilizer includes PP-MA, PE-MA, ABS-MA,

E-MA-GMA, E-VA-GMA, POE-GMA, PE-GMA, ABS-GMA, or combinations thereof. In other words, the compatibilizer may be one or more of the above graft copolymers, which should however not be construed as a limitation in the disclosure.

In some embodiments, the addition amount of the compatibilizer relative to the total weight of the modified polyester resin ranges from 8 wt % to 18 wt %. For instance, the addition amount of the compatibilizer relative to the total weight of the modified polyester resin may range from 10 wt % to 15 wt % to achieve an improved compatibilization effect, which should however not be construed as a limitation in the disclosure.

### Toughening Agent

In some embodiments, the toughening agent includes POE, MBS, PTW, or a combination thereof. In other words, the toughening agent may be one or more of the above polymers, which should however not be construed as a limitation in the disclosure. It is also likely to use other appropriate ACRs as the toughening agent.

In some embodiments, the addition amount of the toughening agent relative to the total weight of the modified polyester resin ranges from 3 wt % to 10 wt %. For instance, the addition amount of the toughening agent relative to the total weight of the modified polyester resin may range from 5wt % to 8wt % to achieve an improved toughening effect, which should however not be construed as a limitation in the disclosure.

### Crystallization Inhibitor

In some embodiments, the crystallization inhibitor includes IPA copolyester, IPA and CHDM copolyester, poly (ethylene terephthalate co-1,4-cyclohexylenedimethylene terephthalate (such as PETG, PCTG, where PETG and PCTG differ in the proportion of CHDM), or combinations thereof. In other words, the crystallization inhibitor may be one or more of the above polymers, which should however not be construed as a limitation in the disclosure.

In some embodiments, the addition amount of the crystallization inhibitor relative to the total weight of the modified polyester resin ranges from 2 wt % to 8 wt %. For instance, the addition amount of the crystallization inhibitor relative to the total weight of the modified polyester resin may range from 4 wt % to 6 wt % to achieve an improved crystallization inhibition effect, which should however not be construed as a limitation in the disclosure.

### Slip Agent

In some embodiments, the slip agent includes stearate, polyethylene wax, modified silicone, fluororesin, or combinations thereof. Namely, the slip agent is one or more of the above-mentioned materials, which should however not be construed as a limitation in the disclosure. Here, stearates refer to zinc stearate, the modified silicone refers to surface-modified silica, and fluororesin refers to PTFE, for instance.

In some embodiments, the addition amount of the slip agent ranges from 0.1 wt % to 2 wt % relative to the total weight of the modified polyester resin. For instance, the addition amount of the slip agent ranges from 0.5 wt % to 1 wt % relative to the total weight of the modified polyester resin to achieve improved flowability, which should however not be construed as a limitation in the disclosure.

### Antioxidant

In some embodiments, the antioxidant includes hindered phenolic antioxidants, phenolic antioxidants, phosphite antioxidants, or combinations thereof. Namely, the antioxidant is one or more of the above-mentioned materials, which should however not be construed as a limitation in the disclosure. Here, the hindered phenolic antioxidants refer to AO-1010, AO-1076, and AO-1315, the phenolic antioxidants refer to AO-20 and GP-45, and the phosphite antioxidants refer to AO-168, AO-618, and TNPP, for instance.

In some embodiments, the addition amount of the antioxidant ranges from 0.1 wt % to 1 wt % relative to the total weight of the modified polyester resin. For instance, the addition amount of the antioxidant ranges from 0.3 wt % to 0.5 wt % relative to the total weight of the modified polyester resin to achieve an improved antioxidant effect, which should however not be construed as a limitation in the disclosure.

Note that the polyester provided in this disclosure is equivalent to polyethylene terephthalate (PET).

Following embodiments and comparative examples are provided to elaborate the effects of the invention, but the claimed scope is not limited to those provided in the embodiments.

ASTM standard test specimens produced in each embodiment and comparative example are evaluated according to following methods.

Specific gravity: measured according to the ASTM D792 standard test method.

Impact resistance: measured according to the ASTM D256 standard test method, and the obtained value (kg-cm/cm) represents the total energy that the test specimen is able to withstand at the point of fracture. A higher value indicates a higher impact resistance (or resistance) of the test specimen.

Tensile strength: measured according to the ASTM D638 standard test method, and the obtained value represents the total energy that the test specimen is able to withstand under tensile deformation. A higher value indicates a higher tensile strength of the test specimen.

Flexural strength: measured according to the ASTM D790 standard test method, and the obtained value represents the resistance of the test specimen to a bending strain and deformation. A higher value indicates a higher flexural strength of the test specimen.

Flexural modulus: measured according to the ASTM D790 standard test method, and the obtained value represents the total energy that the test specimen is able to withstand under a bending strain and deformation. A higher value indicates higher stiffness of the test specimen.

Heat deflection temperature (HDT): measured according to the ASTM D648 standard test method, and the obtained value represents the resistance of the test specimen to thermal deformation. A higher value indicates a higher heat resistance of the test specimen.

Shrinkage: measured according to the ASTM D955 standard test method, and “shrinkage” refers to the differences (in percent) between dimensions of a plastic product undergoing cooling and solidification from the mold and dimensions of the original mold.

### Comparison Examples 1-3 and Embodiments 1-2

ASTM standard test specimens are produced by using the resin compositions in the proportions shown in Table 1 through an injection molding method, and mechanical properties of the test specimens are tested. In Table 1, the composition of the modified polyester resin consists of 77wt % recycled polyester pellets (having the IV of 0.8 dL/g, the recycled source of which is from release film recycled polyester pellets), 12wt % compatibilizer (E-MA-GMA), 5wt % toughening agent (MBS), 5wt % crystallization inhibitor (poly (ethylene terephthalate co-1,4-cylclohexylenedimethylene terephthalate), 0.5wt % slip agent (polyethylene wax), and 0.5wt % antioxidant (AO-1010+AO-168, in a 1:1 ratio). The ABS resin used herein is the product AG12A0 from the Formosa Chemicals & Fibre Corporation, and the unmodified polyester resin used herein is the product PET-3380R from Nan Ya Plastics Corporation (having the IV of 0.8 dL/g).

TABLE 1

| | Comparison | | Comparison | | Comparison | | | | | |
|---|---|---|---|---|---|---|---|---|---|---|
| | example 1 | | example 2 | | example 3 | | Embodiment 1 | | Embodiment 2 | |
| ABS resin | 100 | wt % | 80 | wt % | 70 | wt % | 75 | wt % | 60 | wt % |
| Unmodified polyester | — | | 20 | wt % | 30 | wt % | — | | — | |
| resin | | | | | | | | | | |
| Modified polyester resin | — | | — | | — | | 25 | wt % | 40 | wt % |
| Proportion of recycled | — | | 20 | wt % | 30 | wt % | 19.3 | wt % | 30.8 | wt % |
| polyester pellets | | | | | | | | | | |
| Specific gravity | 1.05 | | 1.11 | | 1.14 | | 1.11 | | 1.13 | |
| Impact resistance | 15.4 | | 9.3 | | 6.7 | | 18.3 | | 15.9 | |
| (kg-cm/cm) | | | | | | | | | | |
| Tensile strength | 44.6 | Mpa | 42.1 | Mpa | 40.8 | Mpa | 45.1 | Mpa | 44.7 | Mpa |
| Flexural strength | 73.3 | Mpa | 71 | Mpa | 68.6 | Mpa | 72.3 | Mpa | 72.5 | Mpa |
| Flexural modulus | 2330 | Mpa | 2230 | Mpa | 2150 | Mpa | 2210 | Mpa | 2190 | Mpa |

| | | | | | |
|---|---|---|---|---|---|
| HDT (0.45 Mpa) (° C.) | 91 | 87 | 84 | 89 | 87 |
| Shrinkage | 0.55% | 0.57% | 0.59% | 0.58% | 0.59% |

The relevant characteristics of the ASTM standard test specimens produced for the tests are tested and detailed in Table 1. After the results of the comparison examples 1-3 and the embodiments 1-2 in Table 1 are compared, the following conclusions may be drawn: in the embodiments 1-2, the impact resistance may be effectively improved while the performance in other characteristics is similar as compared to the comparison examples 1-3. Therefore, there is a clear improvement in the mechanical performance. To be specific, when the unmodified polyester resin provided in the comparison examples 2-3 is introduced into the ABS resin system, phase separation occurs, thus resulting in a significant decrease in the impact resistance, the tensile strength, and the HDT. On the other hand, in the embodiments 1-2, the compatibility issue may be overcome through the use of various additives, thus ensuring that the mechanical properties of the materials are kept to a level similar to that of the ABS resin.

In view of the above, the resin composition provided in one or more embodiments of the disclosure introduces the modified polyester resin (using various additives, such as the compatibilizer, the toughening agent, the crystallization inhibitor, the slip agent, the antioxidant, and a modified polyester material) into the ABS resin system. This may improve the poor compatibility between the two and enhance impact resistance, fluidity, and heat resistance. As a result, an improved mechanical performance may be achieved while the carbon emissions are reduced.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A resin composition, comprising:
ABS resin; and
modified polyester resin, comprising:
a polyester material,
a compatibilizer, comprising PP-MA, PE-MA, ABS-MA, E-MA-GMA, E-VA-GMA, POE-GMA, PE-GMA, ABS-GMA, or combinations thereof,
a toughening agent, comprising POE, MBS, PTW, or combinations thereof;
a crystallization inhibitor, comprising IPA copolyester, IPA and CHDM copolyester, poly (ethylene terephthalate co-1,4-cylclohexylenedimethylene terephthalate, or combinations thereof;
a slip agent, comprising stearate, polyethylene wax, modified silicone, fluororesin, or combinations thereof; and
an antioxidant, comprising a hindered phenolic antioxidant, a phenolic antioxidant, a phosphite antioxidant, or combinations thereof.

2. The resin composition according to claim 1, wherein an addition amount of the compatibilizer ranges from 8 wt % to 18 wt % relative to a total weight of the modified polyester resin.

3. The resin composition according to claim 1, wherein an addition amount of the toughening agent ranges from 3 wt % to 10 wt % relative to a total weight of the modified polyester resin.

4. The resin composition according to claim 1, wherein an addition amount of the crystallization inhibitor ranges from 2 wt % to 8 wt % relative to a total weight of the modified polyester resin.

5. The resin composition according to claim 1, wherein an addition amount of the slip agent ranges from 0.1 wt % to 2 wt % relative to a total weight of the modified polyester resin.

6. The resin composition according to claim 1, wherein an addition amount of the antioxidant ranges from 0.1 wt % to 1 wt % relative to a total weight of the modified polyester resin.

7. The resin composition according to claim 1, wherein an addition amount of the polyester material ranges from 61.0 wt % to 86.8 wt % relative to a total weight of the modified polyester resin.

8. The resin composition according to claim 1, wherein an addition amount of the ABS resin ranges from 60 wt % to 100 wt % relative to a total weight of the resin composition.

9. The resin composition according to claim 8, wherein a total addition amount of the ABS resin and the modified polyester resin is 100 wt %.

10. The resin composition according to claim 1, wherein the polyester material comprises virgin polyester pellets, recycled polyester pellets, or combinations thereof.
